(19) United States
(12) Patent Application Publication
(10) Pub. No.: US 2007/0102907 A1
(43) Pub. Date: May 10, 2007

(54) Inflatable curtains with gas generating cord inflators

(75) Inventor: Paul A. Bowers, Ray, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/268,869

(22) Filed: Nov. 8, 2005

(51) Int. Cl. B60R 21/16

(52) U.S. Cl. 280/730.2; 280/741

(57) ABSTRACT

An apparatus (10) for helping to protect an occupant of a vehicle (12) having a side structure (16), a first row seat (30), and a second row seat (32). The apparatus (10) includes a first inflatable curtain (42) inflatable between the side structure (16) and an occupant of the first row seat (30). A first gas generating cord (52) generates inflation fluid for inflating the first inflatable curtain (42). The apparatus (10) also includes a second inflatable curtain (44) inflatable between the side structure (16) and an occupant of the second row seat (32). A second gas generating cord (54) generates inflation fluid for inflating the second inflatable curtain (44). The apparatus (10) further includes a controller (86) that is operable to cause selective actuation of one or both of the first and second gas generating cords (52 and 54).

### FIELD OF THE INVENTION

The present invention relates to an inflatable vehicle occupant protection device for helping to protect an occupant of a vehicle.

### BACKGROUND OF THE INVENTION

It is known to inflate an inflatable vehicle occupant protection device to help protect a vehicle occupant in the event of a vehicle collision. Examples of inflatable vehicle occupant protection devices include driver and passenger frontal air bags, side air bags, inflatable curtains, inflatable seat belts, inflatable knee bolsters, and inflatable head liners.

An inflatable curtain is inflatable away from the roof of the vehicle to a position between a side structure of the vehicle and occupants of vehicle seating. Typically, an inflation fluid source, such as a stored gas inflator, heated gas inflator, pyrotechnic inflator, hybrid inflator, or augmented inflator, is located externally of the inflatable curtain. In this instance, a conduit, such as a fill tube, delivers inflation fluid from the inflation fluid source to the inflatable curtain.

### SUMMARY OF THE INVENTION

The present invention relates to an apparatus for helping to protect an occupant of a vehicle that has a side structure, a first row seat, and a second row seat. The apparatus includes a first inflatable curtain inflatable between the side structure and an occupant of the first row seat. A first gas generating cord generates inflation fluid for inflating the first inflatable curtain. The apparatus also includes a second inflatable curtain inflatable between the side structure and an occupant of the second row seat. A second gas generating cord generates inflation fluid for inflating the second inflatable curtain. The apparatus further includes a controller that is operable to cause selective actuation of one or both of the first and second gas generating cords.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect an occupant of a vehicle illustrating a deflated and stored position of the protection device, according to the present invention;

FIG. 2 is a schematic view the apparatus illustrating an inflated and deployed position of the protection device; and

FIG. 3 is a schematic block diagram illustrating a portion of the apparatus of FIGS. 1 and 2.

### DETAILED DESCRIPTION OF THE INVENTION

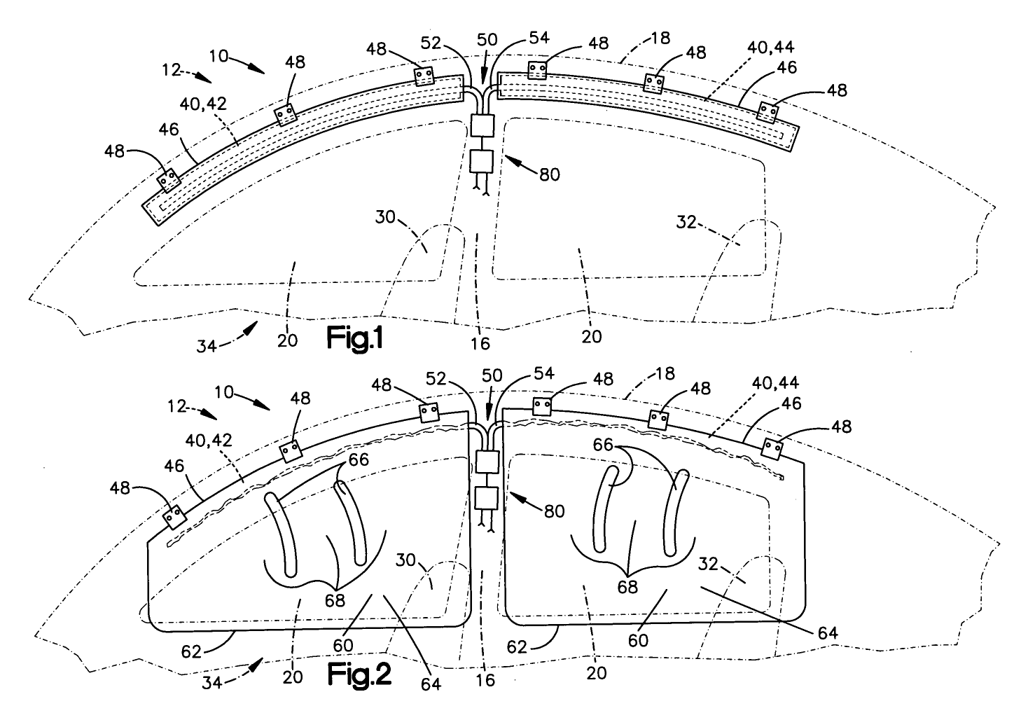

As representative of the present invention, an apparatus 10 helps to protect an occupant of a vehicle 12. As shown in FIGS. 1 and 2, the vehicle 12 includes a side structure 16 and a roof 18. The roof 18 may be either a standard roof that is fixed in place or a convertible roof that can be moved or removed. The side structure 16 includes side windows 20 and extends along the length of the vehicle adjacent first row or front seating 30 and second row or rear seating 32 of the vehicle 12.

The side structure 16 shown in FIGS. 1 and 2 is on a driver side 34 of the vehicle 12. Those skilled in the art will appreciate that the vehicle 12 also includes a similarly or identically configured side structure on a passenger side (not shown) of the vehicle. It will thus be appreciated that the apparatus 10 of the present invention may be associated with the driver side 34 or passenger side of the vehicle 12. The apparatus 10 may help protect driver side or passenger side occupants of the first row seating 30 and second row seating 32.

The apparatus 10 includes inflatable vehicle occupant protection devices in the form of inflatable curtains 40. The inflatable curtains 14 include a first or front inflatable curtain 42 and a second or rear inflatable curtain 44. The inflatable curtains 40 are mounted adjacent the intersection of the side structure 16 and roof 18 of the vehicle 12 and are inflatable from a deflated and stored position of FIG. 1 to an inflated and deployed position of FIG. 2. The first inflatable curtain 42, when in the inflated and deployed position, is positioned between the side structure 16 and any occupants of the first row seating 30. The second inflatable curtain 44, when in the inflated and deployed position, is positioned between the side structure 16 and any occupants of the second row seating 32.

The apparatus 10 also includes an inflation fluid source 50 for providing inflation fluid for inflating the inflatable curtains 40. The inflation fluid source 50 provides a volume of inflation fluid sufficient to inflate the inflatable curtains 40 and maintaining the curtains in the inflated and deployed position (FIG. 2) for a desired duration, such as at least two seconds, at least five seconds, or longer.

The inflation fluid source 50 comprises a first or front gas generating cord 52 associated with the first inflatable curtain 42, and a second or rear gas generating cord 54 associated with the second inflatable curtain 44. The gas generating cords 52 and 54 include an ignitable gas generating material that is distributed along the length of the cords. The gas generating cords 52 and 54 may have any known construction. For example, the gas generating cords 52 and 54 may have any of the constructions disclosed in U.S. Pat. No. 6,062,143, issued to Simula, Inc. of Phoenix, Ariz.

The apparatus 10 may also include one or more housings 46 that store the inflatable curtains 40 in the deflated and stored position. The deflated inflatable curtains 40 and housings 46 have an elongated configuration and extend along the vehicle roof 18 and along the side structure 16 of the vehicle 12 above the side windows 20. The housings 46 may have a variety of constructions. For example, the housings 46 may comprise fabric sheaths or plastic housings. The apparatus 10 may also include means 48, such as clamps or brackets, for connecting the inflatable curtains 40, housings 46, and gas generating cords 52 and 54 to the vehicle 12.

The inflatable curtains 40 may have any suitable construction. For example, referring to FIG. 2, the inflatable curtains 40 may include panels 60 of material that are arranged in an overlying manner and that have portions secured together. For instance, the panels 60 may be secured together along at least a portion of perimeters of the inflatable curtains 40 to form perimeter connections 62 of the curtains. The perimeter connections 62 may help define inflatable volumes 64 of the inflatable curtains 40.

The inflatable curtains 40 may also include interior connections 66 in which the overlying panels 60 are secured together within the perimeter of the curtains. The interior connections 66 form non-inflatable portions of the inflatable curtains 40. The interior connections 66 also help define inflatable chambers 68 of the inflatable curtains 40. The configuration of the interior connections 66 and the chambers 68 may vary depending on a variety of factors, such as the architecture of the vehicle 12, the position of the inflatable curtains 40 in the vehicle, and the desired extent or coverage of the curtains. For example, the configuration of the interior connections 66 and the inflatable chambers 68 of the front inflatable curtain 42 may be different than the configuration of the interior connections and inflatable chambers of the rear inflatable curtain 44.

The perimeter connections 62 and interior connections 66 may be formed in a variety of manners. For example, the connections 62 and 66 may be formed by weaving the panels 60 as a single piece of material. Alternatively, the connections 62 and 66 may be formed by stitching the panels together, or interconnecting the panels by ultrasonic welding, heat bonding, adhesives, or a combination of these methods.

The panels 60 may be woven from a material, such as nylon yarn or polyester yarn. A sealant may be applied to the panels 60 to give the inflatable curtains 40 a desired degree of gas permeability. For example, the sealant may provide the inflatable curtains with a substantially gas impermeable construction. The panels 60 may have alternative constructions, such as a plastic film construction or a multilayered construction including fabric layers, plastic film layers, or both fabric layers and plastic film layers.

The apparatus 10 also includes an actuation system 80 for actuating the first and second gas generating cords 52 and 54 in response to an event for which inflation of the curtains 40 is desired, such as a vehicle collision, a vehicle rollover, or both. According to the present invention, the actuation system 80 may actuate the first gas generating cord 52, second gas generating cord 54, or both, in response to the event for which inflation of the curtains 40 is desired.

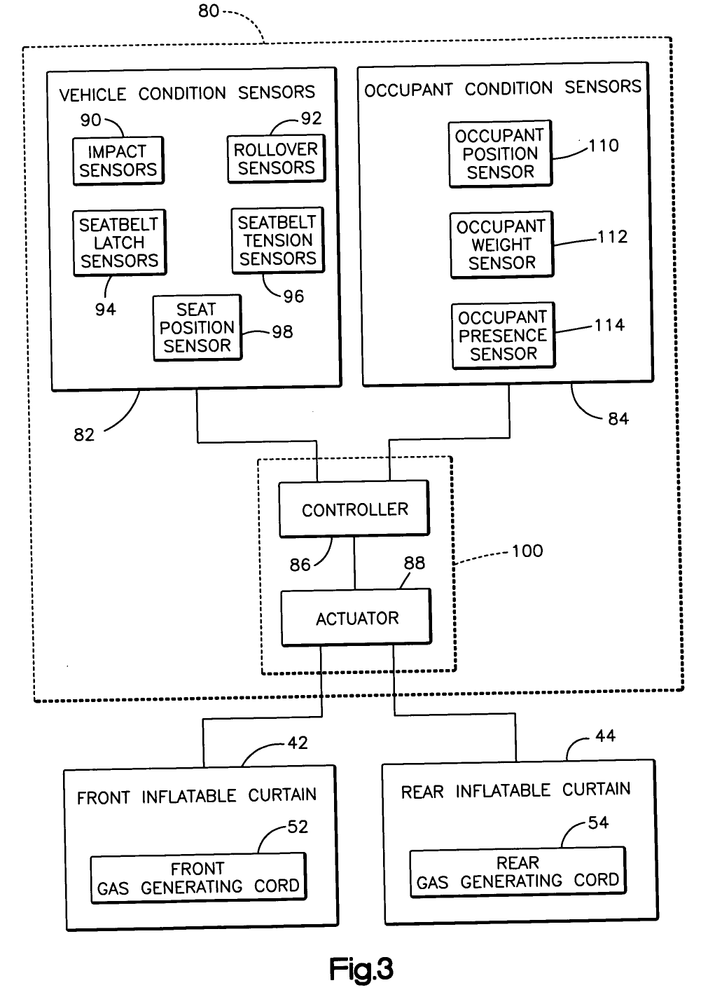

Referring to FIG. 3, the actuation system 80 includes one or more vehicle condition sensors 82, one or more occupant condition sensors 84, a controller 86, and an actuator 88. The vehicle condition sensors 82 are operative to sense vehicle conditions that indicate the occurrence of an event for which occupant protection is desired. For example, as shown in FIG. 3, the vehicle condition sensors 82 may include one or more impact sensors 90, one or more rollover sensors 92, or a combination of impact and rollover sensors. The impact sensors 90 may be operative to sense a variety of vehicle impacts, such as side impacts, front impacts, rear impacts, offset impacts, and angled impacts. The information provided by the vehicle condition sensors 82 thus may be used to determine whether inflation of one or both of the inflatable curtains 40 is necessary.

The vehicle condition sensors 82 may also be operative to sense vehicle conditions that indicate which of the inflatable curtains 40 to inflate. For example, as shown in FIG. 3, the vehicle condition sensors 82 may include seatbelt latch sensors 94, seatbelt tension sensors 96, seat position sensors 98, or a combination of these sensors.

The seat belt latch sensors 94 are operative to detect a latched condition of the seat belt buckle associated with a particular vehicle seat. The seat belt tension sensors 96 are operative to detect the amount of tension on a seat belt associated with a particular vehicle seat. The seat position sensors 98 may be operative to sense a variety of seat position characteristics for a particular vehicle seat, such as a forward/rearward position of the seat and an forward/rearward tilt position of the seat.

The occupant condition sensors 84 are operative to sense occupant conditions that may be used to determine which of the inflatable curtains 40 to inflate. For example, the occupant condition sensors 84 may include an occupant position sensor 110, an occupant weight sensor 112, an occupant presence sensor 114, or a combination of these sensors.

The occupant position sensor 110 may be a device, such as an ultrasonic transducer, that is operative to provide an output indicative of an occupant's position in the vehicle 12. For example, the occupant position sensor 110 may be used to determine an occupant's position relative to vehicle structure, such as the side structure 16, or relative to an expected deployment trajectory of the inflatable curtain 40. It will be appreciated that such an ultrasonic transducer may also be operative to provide an output indicative of an occupant's size. The occupant presence sensor 114 may be a device, such as a switch mounted on the vehicle seating 30 and 32, that is actuated and provides a corresponding output in response to an occupant's presence on the seat.

The controller 86 may include one or more electronic devices suited to perform the control functions described herein. For example, the controller 86 may include one or more microcontrollers, microprocessors, state machines, discrete components, one or more application specific integrated circuits (“ASIC”), or a combination of these electronic devices. The controller 86 is operative to receive signals from the vehicle and occupant condition sensors 82 and 84. The controller 86 is operative to evaluate these vehicle and occupant condition signals in order to determine whether to actuate one or both of the inflatable curtains 40. This function may be implemented in the controller 86 with software or a combination of hardware and software.

The actuator 88 is operative to selectively actuate one or both of the inflatable curtains 40 in response to an actuation signal received from the controller 86. The actuator 88 is also operative to actuate one or both of the gas generating cords 52 and 54 in response to the actuation signal. As shown generally at 100 in FIG. 3, the controller 86 and actuator 88 may be incorporated into a single device or unit.

The vehicle condition sensors 82 and occupant condition sensors 84 monitor their respective conditions continuously or routinely during operation of the vehicle 12. Upon the occurrence of an event for which inflation of a curtain 40 is desired, the appropriate vehicle condition sensor 82 provides a signal, indicative of the sensed event, to the controller 86. For example, upon the occurrence of a vehicle impact, one or more vehicle impact sensors 90 may provide a signal indicative of the sensed impact event to the controller 86. As another example, upon the occurrence of a vehicle rollover, one or more vehicle rollover sensors 92 may provide a signal indicative of the sensed rollover event to the controller 86. In response to receiving this signal from the vehicle condition sensor 82, the controller 86 determines whether to actuate the front gas generating cord 52 to inflate the front inflatable curtain 42, the rear gas generating cord 54 to inflate the rear inflatable curtain 44, or both gas generating cords to inflate both inflatable curtains.

To determine whether to actuate the front gas generating cord 52, the rear gas generating cord 54, or both gas generating cords, the controller 86 takes into account vehicle condition data provided by the vehicle condition sensors 82, occupant condition data provided by the occupant condition sensors 84, or both vehicle and occupant condition data. For example, the controller 86 may inhibit inflation of an inflatable curtain 40, such as the front passenger side curtain, a rear curtain, or a combination of these curtains, if a determination is made that the vehicle seat corresponding to these curtains is unoccupied. The unoccupied seat condition may be determined from data provided by one or more of the occupant condition sensors 84, such as the occupant position sensor 110, the seat weight sensor 112, the occupant presence sensor 114, or a combination of these sensors.

As another example, the controller 86 may inhibit inflation of an inflatable curtain 40, such as the front passenger side curtain, a rear curtain, or a combination thereof, if a determination is made that the corresponding seat is occupied by an object other than an occupant. For instance, the seatbelt latch sensor 94 and tension sensor 96 may indicate that the seatbelt buckle is latched and the belt is under high tension. This may indicate that a child safety seat is cinched down tightly in the seat. In this instance, it may be desirable to inhibit actuation of the corresponding inflatable curtain 40.

As a further example, the controller 86 may inhibit inflation of an inflatable curtain 40, such as the front passenger side curtain, a rear curtain, or a combination thereof, if a determination is made that the occupant of the seat is positioned away from a normal seated position. For instance, the occupant position sensor 110 may indicate that an occupant is leaned against the vehicle side structure 16, e.g., an occupant sleeping in the passenger seat. In another instance, the occupant position sensor 110 may indicate that an occupant is positioned in the expected deployment trajectory of the inflatable curtain 40. In either of these instances, it may be desirable to inhibit actuation of the corresponding inflatable curtain 40.

Once the controller 86 determines which of the inflatable curtains 40 to inflate, the controller provides an appropriate signal to the actuator 88. The actuator 88 actuates the front gas generating cord 52, the rear gas generating cord 54, or both the front and rear gas generating cords in response to the signal from the controller 86. Upon actuation, the front and rear gas generating cords 52 and 54 generate inflation fluid for inflating the front and rear inflatable curtains 42 and 44, respectively.

The inflatable curtains 42 and 44 inflate under the pressure of the inflation fluid from their respective gas generating cords 52 and 54. The housings 46 open and the inflatable curtains 42 and 44 inflate and deploy in a direction away from the roof 18 in a downward direction as shown in the drawings and in a downward direction with respect to the direction of forward travel of the vehicle 12 into the inflated and deployed condition of FIG. 2.

The inflatable curtains 42 and 44, when inflated, extend along the side structure 16 of the vehicle 12 and are positioned between the side structure and any occupants of the first and second row seating 30 and 32, respectively.

From the above description of the invention, those skilled in the art will perceive improvements, changes and modifications. Such improvements, changes and modifications within the skill of the art are intended to be covered by the appended claims.

Having described the invention, the following is: claimed:

1. An apparatus for helping to protect an occupant of a vehicle having a side structure, a first row seat, and a second row seat, said apparatus comprising:
a first inflatable curtain inflatable between the side structure of the vehicle and an occupant of the first row seat;
a first gas generating cord for generating inflation fluid for inflating said first inflatable curtain;
a second inflatable curtain inflatable between the side structure of the vehicle and an occupant of the second row seat;
a second gas generating cord for generating inflation fluid for inflating said second inflatable curtain; and
a controller operable to cause selective actuation of one or both of said first and second gas generating cords.

2. The apparatus recited in claim 1, further comprising sensor means for sensing at least one of vehicle and occupant conditions, said controller being operative to cause selective actuation of one or both of said first and second gas generating cords in response to at least one of vehicle and occupant conditions sensed by said sensor means.

3. The apparatus recited in claim 2, wherein said sensor means comprises at least one of a seat belt latch sensor, a seat belt tension sensor, a seat position sensor, an occupant presence sensor, an occupant position sensor, and an occupant weight sensor.

4. The apparatus recited in claim 1, further comprising an actuator operative to receive a signal from said controller indicative of which of said first and second inflatable vehicle occupant protection devices are to be inflated, said actuator being further operative to actuate selectively one or both of said first and second gas generating cords in response to said signal from said controller.

5. The apparatus recited in claim 1, wherein said first gas generating cord extends along a substantial portion of the length of said first inflatable vehicle occupant protection device, and said second gas generating cord extends along a substantial portion of the length of said second inflatable vehicle occupant protection device.
